(19) United States
(12) Patent Application Publication
(10) Pub. No.: US 2020/0157968 A1
(43) Pub. Date: May 21, 2020

(54) Insert Piece for a Turbocharger

(71) Applicant: MAN Energy Solutions SE, Augsburg (DE)

(72) Inventors: Steffen BRAUN, Augsburg (DE); Frank GRIEßHABER, Augsburg (DE); Vladimir HORT, Velká Bites (CZ); Roland KRAUß, Niederschönenfeld (DE); Boris THASER, Augsburg (DE)

(21) Appl. No.: 16/688,554

(22) Filed: Nov. 19, 2019

(30) Foreign Application Priority Data
Nov. 20, 2018 (DE) 10 2018 129 128.0

(51) Int. Cl. F01D 21/04; F01D 25/24

(52) U.S. Cl. CPC F01D 21/045; F05D 2220/40; F01D 25/24

(57) ABSTRACT

A burst protection device is provided for a radial turbocharger having a turbine housing completely enclosing a turbine wheel rotatably arranged in the turbine housing, and turbine housing inner wall. The burst protection device is annularly arranged in the radial turbocharger about a central axis (A) in a circumferential direction on the turbine housing inner wall, so as to at least partly engage about the turbine wheel. The burst protection device defines at least one recess/hollow space. The at least one recess/hollow space is configured such that kinetic energy of fragments of the turbine wheel produced upon bursting of the turbine wheel is absorbed by the burst protection device based on plastic deformation of the at least one recess/hollow space, a first one of the at least one recess/hollow space being unilaterally open in a direction of the turbine housing.

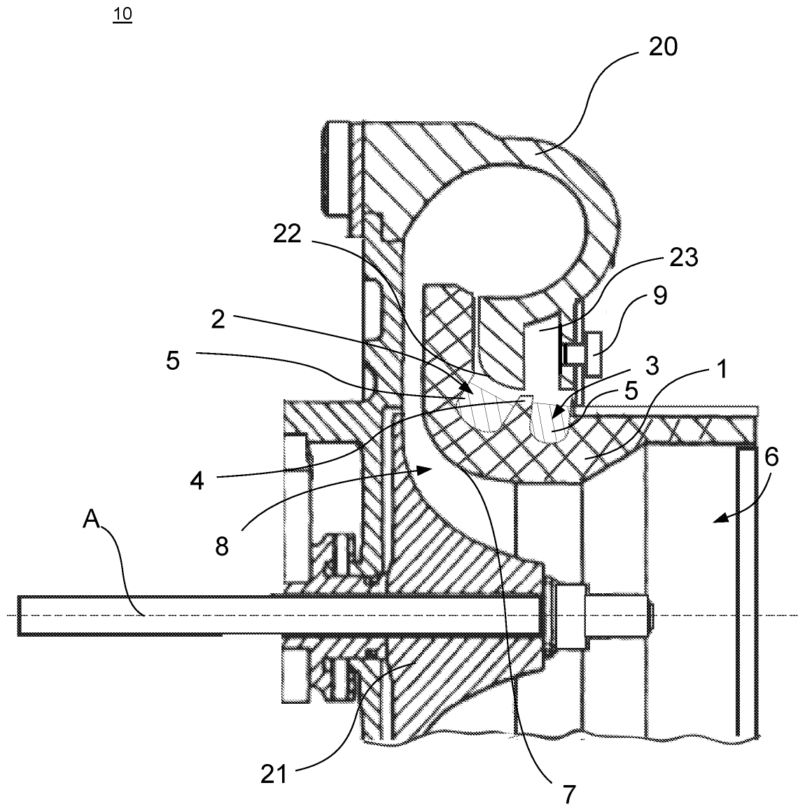

### BACKGROUND OF THE INVENTION

### 1. Field of the Invention

The invention relates to an insert piece as burst protection device for a turbocharger, in particular radial turbocharger, having a turbine housing which completely encloses a turbine wheel that is rotatably arranged in the turbine housing.

### 2. Description of the Related Art

Currently known high performance turbomachines, such as for example exhaust gas turbochargers of supercharged internal combustion engines pose a high risk for their surroundings in the case of a technical failure of the rotating parts of the turbocharger. In particular, when operating in situations in which persons can be present in the immediate vicinity of the turbocharger, it must be ensured that in the event of a failure, i.e., during bursting, all parts are securely and completely intercepted and cannot injure any person.

In the past, in order to prevent fragments striking through the outer wall of the turbocharger, and thus the endangering of persons or damage to adjacent machine parts, turbochargers were provided with relatively thick walls in the turbine housing in the region radially outside the turbine impeller. However, these solutions have a number of disadvantages such as, for example, the substantial additional weight of the housing and the risk of blowholes forming because of poorer castability of such a turbine housing. In addition, a housing thickened in such a manner heats up differently, which can result in thermal cracks.

From DE 42 23 496 A1 a device for reducing the kinetic energy of bursting parts for machines rotating with high speed is known. This device, arranged in the interior of an axial turbine, consists of multiple interconnected protective rings between each of which a crumbling zone produced from ductile material is formed. However, such a solution is not suitable for radial turbines since, because of their radial gas inlet, no burst protection devices can be employed in the radial region of the turbine.

From the publication U.S. Pat. No. 4,875,837 a multi-layer burst protection is known, with which a heat-insulating material is introduced into an iron plate and which, spaced from a turbine housing is attached to a spiral part of the turbine housing. However, the circumstance that the burst protection described in U.S. Pat. No. 4,875,837 encloses only a 120° angular range of the spiral part of the housing, and is thus designed partly open, is disadvantageous.

From the publication DE 196 40 654 A1 a further burst protection is known, which is provided outside a gas inlet housing of a radial turbine for a turbocharger, which is formed as spiral sheet metal shroud and detachably connected to the gas inlet housing by way of multiple screws.

Furthermore, solutions are known with which bent metal sheets are arranged as burst protection about the spiral part. While such solutions are simple in design and reduce the production costs, they exhibit limited strength and stiffness and behave unfavorably with respect to reaction to the natural frequencies that occur during operation.

### SUMMARY OF THE INVENTION

An object of the present invention therefore is to avoid the disadvantages discussed above and to create an improved burst protection device for radial turbines of a turbocharger that is easy to produce and safe, thereby further improving the safety of turbochargers.

According to an aspect of the invention, an insert piece as burst protection device for a turbocharger, in particular a radial turbocharger, with a turbine housing is therefore proposed which fully encloses a turbine wheel that is rotatably arranged in the turbine housing. The burst protection device is annularly arranged about a central axis in the circumferential direction on the turbine housing inner wall to at least partly engage about the turbine wheel. The burst protection device comprises at least one first recess/hollow space. This recess/hollow space is formed in the burst protection device so that the kinetic energy of fragments of the turbine wheel, upon its bursting, is absorbed by the burst protection device because of plastic deformation of the burst protection device into the recess or into the hollow space. For this purpose, the first recess is unilaterally open in the direction of the turbine housing.

Because of the load-appropriate design of the burst protection device near the rotor, the kinetic energy of a rotor component can already be removed during the occurrence of an initial failure in particular the bursting of a rotor component through targeted deformation directly in the region of the at least one recess/hollow space and the forces that occur directed into structures, which, upon failure, do not create a risk of injury to persons in the vicinity. Here, a hollow space is an enclosed hollow space that is empty or filled with a medium in the interior of the burst protection device. A targeted deformation up to a desired local failure of the burst protection device is assumed to be load-appropriate so that an unintentional load distribution over other structural regions is avoided. Because of a targeted matching of a stiffness of the burst protection device by the at least one recess/hollow space, a maximum of rotating energy can already be removed in the interior of the gas turbomachine in the event of a failure. The geometrical configuration of the recess is decisive for absorbing the kinetic energy and for the deformation of the burst protection device. The effect of the energy absorption is favored in that the at least first recess is open in the direction of the turbine housing since forces acting in the direction of the turbine housing in this way initially cause a deformation of the burst protection device and proportions of these forces are directed on to other structures before the forces are transmitted to the turbine housing.

In an advantageous embodiment aspect it is provided that the at least one first recess/hollow space completely passes through the burst protection device radially in the manner of a channel. Here it is favorable that thereby a recess for absorbing the kinetic energy of fragments of the turbine wheel upon its bursting is made available over the entire radial circumference of the burst protection device.

In one aspect, the burst protection device is preferentially formed in one piece. This simplifies the targeted adaptation of the stiffness and orientation of the deformation since no further peripheral conditions resulting from a multi-part burst protection device need be taken into account. The energy absorption and passing on of force is thus favored.

In an exemplary embodiment of the invention the turbine housing inner wall comprises a turbine housing recess that radially passes through the turbine housing partly or completely and is unilaterally open in the direction of the burst protection device. This is advantageous in that by the turbine housing recess a region is formed, which makes available space for receiving deformed regions of the burst protection device. Because of this, the burst protection device initially deforms in the direction of the turbine housing recess and, in the process, absorbs a large part of the kinetic energy of the burst turbine wheel components before this kinetic energy is directly passed on further into the turbine housing.

Further favorable is an embodiment in which the burst protection device has a second recess separate and spaced from the first recess, radially passes through the burst protection device partly or completely in the manner of a channel and is unilaterally open in the direction of the turbine housing. A further recess/hollow space optimizes the burst protection device regarding its deformation and absorption of the kinetic energy.

Preferentially, the burst protection device is configured so that the recess/hollow space is arranged in the radial direction located opposite the turbine housing recess. Because of this arrangement of the recess/hollow space, a deformation of the burst protection device in the direction of the turbine housing recess is favored.

In a further advantageous aspect the burst protection device has, between the first and second recess/hollow space, a projection extending in the radial direction that preferentially lies with its face end against the turbine housing inner wall. Here it is favorable that the projection during a faultless operation fixes the burst protection device against position changes in the radial direction by lying against the turbine housing inner wall. In a region adjoining the turbine housing recess, the projection lies against the turbine housing. This causes the projection during the deformation of the burst protection device because of a burst turbine wheel to be deformed into the turbine housing recess, as a result of which initially a major part of the kinetic energy of the burst turbine wheel components is converted into the deformation energy of the burst protection device, instead of directing all energy directly via the projection to the turbine housing.

In another aspect, at least one recess/hollow space has a filling for absorbing at least a part of the kinetic energy of fragments of the turbine wheel upon its bursting. Here it is favorable that the filling consists of a plastically deformable material which further optimizes the energy absorption by the burst protection device.

It is advantageous, furthermore, when an inner wall of the burst protection device directed radially to the inside forms an exhaust gas inlet on one side and the burst protection device, in a cross-sectional direction, is formed in funnel-like shape.

In another aspect, the inner wall of the burst protection device forms a flow passage with the turbine wheel. In an advantageous embodiment, an end portion of the burst protection device lies against the turbine housing inner wall at an outlet of the flow passage so that the opening of the first recess/hollow space, which is formed between the projection and the end portion, is completely arranged on the turbine housing inner wall.

In another aspect, the burst protection device is detachably fixed on the turbine housing by a fastener.

A further aspect of the present invention relates to a gas turbomachine, in particular gas radial turbomachine, with a turbine housing comprising a turbine wheel that is rotatably arranged in the turbine housing, and an above-described burst protection device integrated therein.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Other advantageous further developments of the invention are characterized in the subclaims or are presented in more detail by way of the FIGURE together with the description of the preferred embodiment of the invention

The FIGURE is a perspective part-sectional view of an exemplary embodiment of a burst protection device for a gas turbomachine.

### DETAILED DESCRIPTION OF THE PRESENTLY PREFERRED EMBODIMENTS

In the following, the invention is described making reference to the FIGURE by way of an exemplary embodiment.

In the FIGURE, a perspective part-sectional view of an exemplary embodiment of a burst protection device 1 for a gas turbomachine 10 is shown.

The shown gas turbomachine 10 comprises a burst protection device 1 and a turbine housing 20, which comprises a rotatably arranged turbine wheel 21 and completely encloses the turbine wheel 21. Furthermore, the burst protection device 1 formed in one piece is arranged about a central axis A lying against the turbine housing inner wall 22 and almost completely engages about the turbine wheel 21 in this exemplary embodiment. The turbine housing inner wall 22 comprises a turbine housing recess 23, which is unilaterally open in the direction of the burst protection device 1.

The burst protection device 1 comprises a first recess 2 and a second recess 3 that is separate and spaced from the first recess 2. The two recesses 2, 3 in the burst protection device 1 are designed so that the kinetic energy of fragments of the turbine wheel 21 upon its bursting is absorbed in the recesses 2, 3, through the burst protection device 1 because of plastic deformation of the material of the burst protection device 1. For this purpose, the first and the second recess 2, 3 are unilaterally open in the direction of the turbine housing 20. In addition, the second recess 3 is arranged in the radial direction located opposite the turbine housing recess 23.

Furthermore, the burst protection device 1 comprises a projection 4 extending in the radial direction between the first and second recess 2, 3. This projection 4 directly lies with its face end against the turbine housing inner wall 22.

Both recesses 2, 3 of the burst protection device 1 have a filling 5 for absorbing at least a part of the kinetic energy of fragments of the turbine wheel 21 upon its bursting. The outlet of the flow passage 8, an end portion of the burst protection device 1 directly lies against the turbine housing inner wall 22. Thus, the opening of the first recess 2, which is formed between the projection 4 and the end portion, is completely arranged on the turbine housing inner wall 22.

The inner wall 7 of the burst protection device 1 directed radially to the inside unilaterally forms an exhaust gas feed 6. In addition, the burst protection device 1 is funnel-like in the cross-sectional direction and the inner wall 7 of the burst protection device 1 forms a flow passage 8 with the turbine wheel 21.

The burst protection device 1 is detachably fixed to the turbine housing 20 by a fastener 9.

In its embodiment, the invention is not restricted to the preferred exemplary embodiments stated above. A number of versions is rather conceivable which makes use of the shown solution even with embodiments of a fundamentally different type.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A burst protection device (1) for a radial turbocharger (10) having a turbine housing (20) completely enclosing a turbine wheel (21) rotatably arranged in the turbine housing (20), and turbine housing inner wall (22),
wherein:
the burst protection device (1) is annularly arranged in the radial turbocharger about a central axis (A) in a circumferential direction on the turbine housing inner wall (22), so as to at least partly engage about the turbine wheel (21), and
the burst protection device (1) defines at least one recess/hollow space (2, 3), the at least one recess/hollow space (2, 3) being configured such that kinetic energy of fragments of the turbine wheel (21) produced upon bursting of the turbine wheel (21) is absorbed by the burst protection device (1) based on plastic deformation of the at least one recess/hollow space (2, 3), a first one of the at least one recess/hollow space (2) being unilaterally open in a direction of the turbine housing (20).

2. The insert piece (1) according to claim 1, wherein the first one of the at least one recess/hollow space (2) radially passes through the burst protection device (1) partly or completely channel-like.

3. The burst protection device (1) according to claim 1, wherein the burst protection device (1) is formed in one piece or multiple parts.

4. The burst protection device (1) according to claim 1, wherein the turbine housing inner wall (22) comprises a turbine housing recess (23) which partly or completely passes through the turbine housing (20) radially and which is unilaterally open in a direction of the burst protection device (1).

5. The burst protection device (1) according to claim 4, wherein the burst protection device (1) further comprises a second recesses/hollow space (3), separated and spaced from the first recess/hollow space (2), which partly or completely passes through the burst protection device (1) radially channel-like and is unilaterally open in the direction of the turbine housing (20).

6. The burst protection device (1) according to claim 5, wherein the second recess/hollow space (3) is arranged in the radial direction located opposite the turbine housing recess (23).

7. The burst protection device (1) according to claim 6, wherein the burst protection device (1) comprises, between the first and second recess/hollow space (2, 3), a projection (4), extending, in the radial direction, with its face end against the turbine housing inner wall (22).

8. The burst protection device (1) according to claim 7, wherein the at least one recess/hollow space (2, 3) comprises a filling (5) configured to absorb at least a part of the kinetic energy of fragments of the turbine wheel (21) upon bursting of the turbine wheel (21).

9. The burst protection device (1) according to claim 8, further comprising a burst protection device inner wall (7) directed radially inwardly to form an exhaust gas feed (6), wherein the burst protection device (1) is formed funnel-like in a cross-sectional direction.

10. The burst protection device (1) according to claim 9, wherein the burst protection device inner wall (7) forms a flow passage (8) with the turbine wheel (21).

11. The burst protection device (1) according to claim 10, wherein an end portion of the burst protection device (1) lies against the turbine housing inner wall (22) at an outlet of the flow passage (8), so that the opening of the first recess/hollow space (2), arranged between the projection (4) and the end portion, is completely arranged on the turbine housing inner wall (22).

12. The burst protection device (1) according to claim 11, wherein the burst protection device (1) is detachably fixed to the turbine housing (20) by a fastener (9).

13. A gas radial turbomachine (10), comprising:
having a turbine housing (20) having a turbine wheel (21) rotatably arranged in the turbine housing (20), and
the burst protection device (1) according to claim 1.
